(19) United States
(12) Patent Application Publication
(10) Pub. No.: US 2014/0162018 A1
(43) Pub. Date: Jun. 12, 2014

(54) Carpet Products and Methods for Making Same

(71) Applicant: Celanese Emulsions GmbH, Sulzbach (DE)

(72) Inventors: David Lunsford, Fountain Inn, SC (US); Rajeev Farwaha, Belle Mead, NJ (US); Rebekah Stuart, Greer, SC (US)

(73) Assignee: Celanese Emulsions GmbH, Sulzbach (DE)

(21) Appl. No.: 14/099,341

(22) Filed: Dec. 6, 2013

Related U.S. Application Data
(60) Provisional application No. 61/734,581, filed on Dec. 7, 2012.

(51) Int. Cl. D06N 7/00; B32B 37/12

(52) U.S. Cl. CPC D06N 7/0073; B32B 37/12
USPC 428/96; 156/72

(57) ABSTRACT

Disclosed are carpet products made using a first copolymer precoat adhesive to secure carpet fibers to a carpet backing or substrates in combination with a second copolymer skipcoat adhesive for securing a carpet scrim or other layer to a carpet backing. The first copolymer is a copolymer of a vinyl ester and ethylene and a cross-linking comonomer, and the second copolymer is a copolymer of styrene and butadiene. Such emulsions are stabilized with surfactant emulsifiers but are preferably substantially free of protective colloid stabilizers. The first copolymer exhibits an elongation value greater than 125% at 110° C.

### CROSS REFERENCE TO RELATED APPLICATIONS

This is a non-provisional which claims priority to U.S. Provisional Application No. 61/734,581, filed on Dec. 7, 2012, the entirety of which is hereby incorporated by reference.

### FIELD OF THE INVENTION

The present invention relates to carpet products containing a primary precoat adhesive formed from a vinyl ester/ethylene-based emulsion binder, and a secondary backing adhesive formed from a styrene/butadiene-based emulsions binder.

### BACKGROUND OF THE INVENTION

Most conventional carpets comprise a primary backing with yarn tufts in the form of cut or uncut loops extending upwardly from this backing to form a pile surface. For tufted carpets, the yarn is inserted into a primary backing (frequently a woven or nonwoven material) by tufting needles and a pre-coat (i.e., a binder) is applied thereto.

Most residential and commercial carpets are also manufactured with a woven scrim (typically made from polypropylene) attached to the back of the carpet to provide dimensional stability to the carpet. The scrim is attached to the pre-coated carpet back with another binder formulation typically referred to as a skip coat adhesive. The skip coat is applied to the scrim, and the scrim is then applied to the pre-coated backing of the carpet before the assembled carpet elements are sent into a curing oven. The purpose of the skip coat adhesive is to provide a layer of material which will adhere the woven scrim to the back of the carpet.

For both the pre-coat and the skip coat adhesives, the physical properties of the binder are important to their successful utilization in the carpet products. In this regard, there are a number of important requirements which must be met by such adhesives. The adhesive must be capable of being applied to the carpet and dried using the processes and equipment conventionally employed in the carpet industry for latex, e.g. emulsion, coating. The binder composition must provide excellent adhesion to the pile fibers to secure them firmly in the backing. The adhesive will also typically have a high loading of fillers such as calcium carbonate, aluminum trihydrate, barite, feldspar, cullet, flyash and/or recycled carpet backing. In one aspect, the filler is selected from the group consisting of calcium carbonate, ATH aluminum trihydrate, recycled fillers, ground glass, silica, fly ash, and combinations of said fillers. The binders in adhesives for carpet materials are frequently emulsion polymers, i.e., latex compositions, which can comprise copolymers of vinyl esters (such as vinyl acetate) and ethylene. Carpet adhesives based on vinyl ester/ethylene copolymers are disclosed, for example, in U.S. Pat. Nos. 4,735,986; 5,026,765; 5,849,389 and 6,359,076, in U.S. Patent Application Publication No. 2005/0287336 and in WO2011/139267A1, the entireties of which are incorporated herein by reference. These copolymers are prepared by polymerizing appropriate co-monomers in an aqueous emulsion. Such emulsions can be stabilized by adding conventional surfactants (anionic, nonionic, cationic) as emulsifiers. Such emulsions may also be stabilized by including protective colloids such as those based on polyvinyl alcohols (PVOH), ionically modified starches, water-soluble starches, starch ethers, polyacrylic acid, carboxymethyl cellulose, natural gums, gelatin, synthetic polymers, or water-soluble cellulose ethers such as hydroxyethyl cellulose (HEC).

Substantially all-surfactant-based vinyl ester/ethylene (VAE) latex emulsions (i.e., those containing very little or no protective colloid as emulsion stabilizers) are especially desirable from the standpoint of permitting effective compounding of the emulsion with the various types of filler materials which are used in carpet adhesives. Substantially all-surfactant stabilized binder emulsions also provide excellent compatibility with other materials typically used by the carpet industry in carpet manufacture such as styrene-butadiene rubber (SBR) emulsions.

Notwithstanding such filler compounding and compatibility benefits, substantially all-surfactant-based vinyl ester/ethylene emulsions, when serving as carpet adhesives, can lead to some processing problems during carpet manufacture. In particular, such processing problems can manifest themselves when the carpet containing the all-surfactant binder emulsion exits the curing oven at 110° C.-120° C. and then travels over a series of guide rollers and possibly through a shearing machine. Substantially all-surfactant stabilized adhesives have a tendency to transfer to the rollers and create build-up which can cause maintenance issues. In addition, at times this build-up can transfer back to the carpet which can cause gouges in the face of the carpet as it goes through the shearing machine.

International Application WO2011/139267A1, previously incorporated herein by reference, indicates that certain surfactant-stabilized interpolymer binders that are substantially free of protective colloid are particularly well suited for use carpet adhesives. According to this publication, the interpolymer used in the binder is prepared by the emulsion polymerization of (i) one or more vinyl ester monomers, (ii) ethylene and (iii) an unsaturated silane co-monomer (or equivalent non-silicon, unsaturated multi-functional cross-linking comonomer) which is effective to alter interpolymer molecular weight, branching and/or flow properties such that a film formed from the interpolymer exhibits an elongation value of less than 125% at 110° C.

Additional attempts have been made to retain the benefits of substantially all-surfactant-based latex binders while minimizing the processing problems hereinbefore described. Such attempts, for example, have involved the use of vinyl ester-ethylene based emulsions stabilized with both surfactant emulsifiers and protective colloids such as PVOH. While some of such attempts have been somewhat successful, these mixed emulsifier/colloid systems must be very precisely formulated and even then still have a tendency not to provide all of the benefits which could be realized by the use of either type of stabilizer system alone. Accordingly, there continues to be a need to identify carpet adhesives based on vinyl ester/ethylene copolymer emulsions that exhibit all the benefits of substantially all-surfactant stabilized emulsions but which do not result in an unacceptable incidence of adverse processing problems during carpet manufacture. The need also exists for identifying ideal precoat and skipcoat adhesive formulations and combinations of formulations that form robust carpet compositions.

### SUMMARY OF THE INVENTION

It has now been discovered that polymers used in precoat adhesives having elongation values, as defined herein, greater than 125% at 110° C. and preferably less than 500%, less than 400%, less than 350%, or less than 300%, may be suitable for use in a carpet precoat adhesive, particularly when used in combination with a skip coat formed from a styrene/butadiene copolymer emulsion, without substantially impacting carpet processability. The present invention is therefore directed to carpet products which employ such adhesives. Upon drying, the precoat adhesives secure carpet fibers to a carpet backing or substrate, and the skip coat adhesive adhesively secures the carpet scrim to the back of the carpet.

In one embodiment, the invention is to a carpet product, comprising a primary carpet layer comprising carpet fiber, e.g., carpet yarn, tufted into a primary backing and a precoat adhesive adhering said carpet fiber to said primary backing, wherein the precoat adhesive is formed from a latex adhesive comprising a first copolymer of an alkanoic acid having from 1 to 13 carbon atoms, ethylene and a cross-linking co-monomer, wherein the first copolymer exhibits an elongation value greater than 125%, greater than 150%, greater than 175% or greater than 200% at 110° C., and optionally less than 500%, less than 400%, less than 350% or less than 300%; and a secondary backing adhered to said primary backing with a skipcoat adhesive comprising styrene/butadiene second copolymer. The carpet optionally has a tuft bind value, as defined herein, greater than 20 N or greater than 27 N.

In another embodiment, the invention is to a process for forming a carpet product, the process comprising the steps of: (a) providing a precoat adhesive comprising a latex coating composition comprising a first copolymer of an alkanoic acid having from 1 to 13 carbon atoms, ethylene and a cross-linking co-monomer, wherein the first copolymer exhibits an elongation value greater than 125% at 110° C.; (b) providing a primary carpet layer comprising carpet fiber, e.g., carpet yarn, tufted into a primary backing; (c) applying the precoat adhesive to the primary carpet layer; (d) applying a skipcoat adhesive comprising a second copolymer to either or both the primary carpet layer and/or a secondary backing, wherein the second copolymer is a copolymer of at least styrene and butadiene; and (e) drying the precoat adhesive and the skipcoat adhesive under conditions effective to adhere the carpet fiber to the primary backing, and adhere the primary carpet layer to the secondary backing.

In preferred embodiments, the latex adhesive is stabilized with a stabilizing system which comprises one or more anionic and/or nonionic surfactants, said stabilizing system being present in an amount which is effective to disperse the copolymer in the water. The stabilizing system may further comprise polyvinyl alcohol and/or hydroxyethyl cellulose. In some aspects, the stabilizing system comprises less than 1.0 pphm polyvinyl alcohol, less than 0.5 pphm polyvinyl alcohol, or less than 0.1 pphm polyvinyl alcohol.

The first copolymer preferably comprises from 70 to 90 pphm vinyl acetate and from 10 to 30 pphm of ethylene. In another embodiment, the first copolymer is a copolymer of the vinyl ester of an alkanoic acid having from 1 to 13 carbon atoms, ethylene, and an acrylic monomer or ester thereof. In another embodiment, the first copolymer comprises a copolymer of vinyl acetate, vinyl neodecanoate and ethylene. The precoat adhesive optionally has a solids content from 40 to 85 wt. % and may have a viscosity from 2,000 to 60,000 cP. In another embodiment, the first copolymer is a copolymer of at least a vinyl ester of an alkanoic acid having from 1 to 13 carbon atoms, ethylene, a cross-linking co-monomer, and a carboxyl monomer.

The cross-linking co-monomer may vary widely, but optionally is selected from the group consisting of triallyl cyanurate, triallyl isocyanurate, diallyl maleate, diallyl fumarate, divinyl benzene, diallyl phthalate, silanes, and GMA.

The precoat adhesive and/or the skipcoat adhesive may further comprise a filler selected from the group consisting of calcium carbonate, ATH aluminum trihydrate, recycled fillers, ground glass, silica, fly ash, and combinations of said fillers.

Carpet products that utilize carpet adhesives of the foregoing types in the precoat layer may be easily processed without undesirable amounts of the adhesive building up on processing apparatus, particularly when used in combination with a styrene-butadiene based skipcoat adhesive.

### DETAILED DESCRIPTION OF THE INVENTION

### Introduction

The present invention relates to carpet compositions and methods of forming such carpet compositions using a cross-linked vinyl ester/ethylene precoat adhesive in combination with a styrene/butadiene skipcoat adhesive. The precoat adhesive has an elongation value, as defined herein, of greater than 125% at 110° C. and preferably less than 500%, less than 400%, less than 350%, or less than 300%. It has now been discovered that such adhesives may be suitable for use in carpet precoat adhesive, particularly when used in combination with a skip coat formed from a styrene/butadiene copolymer emulsion, without substantially impacting carpet processability. The present invention is therefore directed to carpet products that employ this combination of adhesives. Upon drying, the precoat adhesives secure carpet fibers to a carpet backing or substrate, and the skip coat adhesive adhesively secures the carpet scrim or other layers to the back of the carpet.

The cross-linking comonomer used in forming the first copolymer of the precoat adhesive preferably is an unsaturated cross-linking comonomer. As used herein, the term “cross-linking comonomer” refers to internal cross-linking comonomers that are incorporated into polymer backbone rather than external or coordinating cross-linkers such as carbonates, e.g., ammonium zirconium carbonate (AZC) and potassium zirconium carbonate (KZC). The term “first copolymer” refers to the cross-linked vinyl ester/ethylene copolymer employed in the precoat adhesive, and the term “second copolymer” refers to the styrene/butadiene copolymer employed in the skipcoat adhesive of the present invention.

### Cross-Linked Vinyl Ester/Ethylene Precoat Adhesive

The vinyl esters utilized in the formation of the first copolymer of the latex emulsion are the esters of alkanoic acids, the acid having from one to about 13 carbon atoms. Typical examples include; vinyl formate, vinyl acetate, vinyl propionate, vinyl butyrate, vinyl isobutyrate, vinyl valerate, vinyl-2-ethyl-hexanoate, vinyl isooctanoate, vinyl nonate, vinyl decanoate, vinyl pivalate, vinyl versatate, etc. Of the foregoing, vinyl acetate is the preferred monomer because of its ready availability and low cost. In some embodiments, more than one vinyl ester is employed in the polymerization process. For example, in one embodiment, the copolymer may comprise a copolymer of vinyl acetate, vinyl neodecanoate and ethylene in addition to a cross-linking comonomer, as described below.

The vinyl ester is present in the copolymer in amounts ranging from about 70 pphm to 95 pphm (parts per hundred based on total monomers in the copolymer). More preferably, the vinyl ester content of the interpolyer used in the carpet adhesives herein will range from about 85 pphm to 95 pphm.

The second major component of the first copolymer is ethylene. The second copolymer will generally comprise ethylene in an amount from 5 pphm to 30 pphm. More preferably, ethylene will be present in the first copolymer in an amount ranging from 5 pphm to 15 pphm.

The third component of the copolymer in the binder latex used in the precoat adhesive is a minor amount of a cross-linking co-monomer, preferably an unsaturated cross-linking co-monomer. The specific co-monomer employed may vary widely but in one embodiment the cross-linking co-monomer is selected from the group consisting of triallyl cyanurate, triallyl isocyanurate, diallyl maleate, diallyl fumarate, divinyl benzene, diallyl phthalate, silanes, and glycidyl methacrylate (GMA).

In some embodiments, the cross-linking comonomer corresponds to a substituted silane of the structural Formula I:

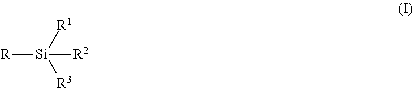

in which R denotes an organic radical olefinically unsaturated in the ω-position and R¹ R² and R³ may be identical or different, denote halogen, preferably chlorine, or the group —OZ, Z denoting hydrogen or primary or secondary alkyl or acyl radicals optionally substituted by alkoxy groups.

Suitable unsaturated silane compounds of the Formula I are preferably those in which the radical R in the formula represents an ω-unsaturated alkenyl of 2 to 10 carbon atoms, particularly of 2 to 4 carbon atoms, or an ω-unsaturated carboxylic acid ester formed from unsaturated carboxylic acids of up to 4 carbon atoms and alcohols carrying the Si group of up to 6 carbon atoms. Suitable radicals R¹, R², R³ are preferably the group —OZ, Z representing primary and/or secondary alkyl radicals of up to 10 carbon atoms, preferably up to 4 carbon atoms, or alkyl radicals substituted by alkoxy groups, preferably of up to 3 carbon atoms, or acyl radicals of up to 6 carbon atoms, preferably of up to 3 carbon atoms, or hydrogen. Most preferred unsaturated silane co-monomers are vinyl trialkoxy silanes.

Examples of preferred silane compounds of the Formula I include vinyltrichlorosilane, vinylmethyldichlorosilane, γ-methacryloxypropyltris(2-methoxyethoxy)silane, vinylmethoxysilane, vinyltrimethoxysilane, vinyltriethoxysilane, vinyldiethoxysilanol, vinylethoxysilanediol, allyltriethoxysilane, vinyltripropoxysilane, vinyltriisopropoxysilane, vinyltributoxysilane, vinyltriacetoxysilane, trimethylglycolvinylsilane, γ-methacryloxypropyltrimethylglycolsilane, γ-acryloxypropyltriethoxysilane and γ-methacryloxypropyltrimethoxysilane.

The cross-linking co-monomer as described herein preferably is selected and used in forming the copolymer of the adhesives used herein in amounts that are effective to alter copolymer molecular weight, branching and/or flow properties in a certain manner. In particular, such copolymer properties should be altered by the cross-linking co-monomer such that a film formed from the copolymer exhibits selected elongation values in the Film Elongation Test as described hereinafter in the Test Methods section. For purposes of this invention, the term “altered” means changed from the properties which would be exhibited by the same type of vinyl ester/ethylene copolymer prepared without the cross-linking co-monomer incorporated therein.

It has been found that when the first copolymer is cast into a test film, and when that test film exhibits elongation values greater than 125% in the Film Elongation Test at 110° C., then some carpet products utilizing a precoat adhesive comprising such a copolymer, along with the other composition components described herein, can be processed with an acceptably low incidence of processing problems, in particular when such adhesives are employed as a carpet precoat in combination with a styrene/butadiene-based skipcoat adhesive. This means that the binder in an adhesive based on such a copolymer will not transfer to any unacceptable extent to processing rollers as carpet passes therethrough, particularly if the binder is incorporated in a precoat. Accordingly, binder build-up on rollers as well as potential transfer back problems can be minimized or avoided. In alternative embodiments, the first copolymer used in the precoat adhesive employed in the carpet products herein may exhibit elongation values greater than 125%, greater than 150%, greater than 175%, greater than 200% or greater than 300%, or optionally, in terms of ranges, from 125% to 500%, e.g., from 125% to 350%, from 150% to 325% or from 175% to 300%, in the Film Elongation Test at 110° C.

Copolymers having the requisite effect on test film elongation properties are generally those made using from about 0.1 pphm to 0.5 pphm, e.g., 0.1 to 0.3 pphm, of the cross-linking co-monomer, e.g., unsaturated silane co-monomer, along with the aforementioned amounts of vinyl ester and ethylene co-monomers. More preferably, the amount of unsaturated cross-linking co-monomer used to form the copolymer will range from about 0.2 pphm to 0.3 pphm. It will be appreciated by those skilled in the art that some variability in elongation should be expected even at the recited cross-linker content depending, for example, on preparation conditions, the specific cross-linking co-monomer selected, and the level of incorporation of the cross-linking co-monomer. As a result, copolymers formed using these cross-linking co-monomers in the recited amounts may have elongation values greater than or possibly less than 125%, and care should be taken to ensure that the desired degree of elongation is attained.

As indicated, the type of cross-linking co-monomer employed may vary widely, and in some aspects, may comprise a non-silicon-containing cross-linking co-monomer. Such non-silicon-containing co-monomers could be, for example, any unsaturated, multi-functional, cross-linking co-monomers which, when incorporated into the copolymer in appropriate amounts, provide copolymers which exhibit elongation values greater 125%, e.g., greater than 150% or greater than 175%, in the Elongation Test.

Suitable non-silicon-containing cross-linking co-monomers can include, for example, unsaturated compounds that contain one or more carbonyl moieties. Preferred co-monomers of this type include those having two or more carbonyl moieties. Examples of such suitable co-monomers include diacetone acrylamide (DiAAA), polymerizable 1,3-dicarbonyl compounds and polymerizable 1,3-diketoamides. Additional non-silicon-containing cross-linking co-monomers include triallyl cyanurate, triallyl isocyanurate, diallyl maleate, diallyl fumarate, divinyl benzene, diallyl phthalate, and GMA.

Suitable polymerizable 1,3-dicarbonyl compounds include acetoacetoxyethyl acrylate, acetoacetoxyethyl methacrylate (AEEM), acetoacetoxypropyl methacrylate, acetoacetoxybutyl methacrylate, 2,3-di(acetoacetoxy)propyl methacrylate and allyl acetoacetate.

Suitable polymerizable 1,3-diketoamides include those compounds described in U.S. Pat. No. 5,889,098, which patent is incorporated herein by reference. Examples of compounds of this type include amido acetoacetonates such as 3-isopropenyl-α,α-dimethylbenzyl amidoacetoacetate, 4-isopropenyl-α,α-dimethylbenzyl amidoacetoacetate, 4-ethylenyl-phenyl amidoacetoacetate and the like.

Preferred unsaturated, multi-functional, carbonyl-containing co-monomers of the foregoing types include diacetone acrylamide (DiAAA), acetoacetoxyethyl methacrylate (AEEM), acetoacetoxypropyl methacrylate, acetoacetoxybutyl methacrylate, 2,3-di(acetoacetoxy)propyl methacrylate and allyl acetoacetate. Diacetone acrylamide and acetoacetoxyethyl methacrylate are the most preferred.

Typically unsaturated, carbonyl-functional co-monomers of these types can be present in the polymerization mixture in amounts ranging from about 0.1 to 0.5 pphm. More preferably such co-monomers will be present in amounts from about 0.1 to 0.3 pphm.

It may also be desired to optionally incorporate into the copolymer minor amounts of certain additional co-monomer types which assist in the stabilizing of the latex emulsion which is formed. Such stabilizing co-monomers are those which are ionic in character by virtue of containing acid moieties or the salts or half-esters of such acid moieties.

Such optional ionic monomers preferably are selected from α,β-ethylenically unsaturated C₃-C₈ monocarboxylic acids, α,β-ethylenically unsaturated C₄-C₈ dicarboxylic acids and the anhydrides thereof, the C₄-C₈ alkyl half-esters of the α,β-ethylenically unsaturated C₄-C₈ dicarboxylic acids, and unsaturated substituted sulfonic acids. Exemplary monomers of this type include acrylamido methyl propane sulfonic acid, styrene sulfonate, sodium vinyl sulfonate, acrylic acid and methacrylic acid, and the C₄-C₈ alkyl half esters of maleic acid, maleic anhydride, fumaric acid, and itaconic acid.

The foregoing types of optionally present ionic co-monomers, if employed, are preferably added in very low amounts of from 0.1 pphm to 5.0 pphm. More preferably, if used the optional ionic co-monomers will comprise from about 0.2 pphm to 1.5 pphm of the monomer mixture.

The copolymer comprising the essential and optional co-monomers hereinbefore described can be prepared using conventional emulsion polymerization procedures which result in the preparation of carpet adhesives used in this invention in aqueous latex form. Such procedures are described, for example, in U.S. Pat. No. 5,849,389, the disclosure of which is incorporated herein by reference in its entirety.

### Styrene/Butadiene Skipcoat Adhesives

As indicated above, the invention relates to carpet compositions and to methods of forming such compositions, using the combination of a crosslinked vinyl ester-based precoat adhesive and a skipcoat adhesive comprising a second copolymer of styrene/butadiene.

The raw materials used to form the second dispersion, for example, typically include the monomers (styrene and butadiene), water, an emulsifier, an initiator system, a modifier, a free radical scavenger (e.g., dimethyl dithiocarbamate or diethyl hydroxylamine) and a stabilizer system. The polymerization process may be performed batch wise or continuously. In a continuous process, the monomers are metered into the reactor chains and emulsified with the emulsifiers and catalyst. The initiator system may be a redox reaction between, for example, chelated iron and an organic peroxide using a reducing agent, e.g., sodium formaldehyde sulfoxide (SFS). Alternatively, potassium peroxydisulfate may be used as the initiator. The process may be conducted as a cold polymerization process or a hot polymerization process. A mercaptan chain transfer agent may be used to provide free radicals and to control molecular weight distribution. During polymerization, the reaction conditions, e.g., temperature, flow rate, and agitation may be controlled to provide the desired level of conversion.

The relative amount of monomers for the second dispersion also may vary. Styrene may be present, for example, in an amount from 5 to 50 pphm, from 10 to 40 pphm, from 20 to 30 pphm, or from 20 to 80 pphm, and butadiene may be present in an amount from 50 to 95 pphm, from 60 to 90 pphm, from 70 to 80 pphm or from 20 to 80 pphm, based on the total monomer in the second dispersion. Other functional co-monomers that add carboxylate or other functionality, may be incorporated into the SB structure during formation of the second polymer. Exemplary functional co-monomers include acrylic acid, methacrylic acid, itaconic acid, and fumaric acid, among others well known to those skilled in the art.

For further description of exemplary processes for manufacturing styrene/butadiene copolymers, see Harper C.A., Handbook of Plastic and Elastomers, McGraw-Hill, New York (1975), the entirety of which is incorporated herein by reference. See also, U.S. Pat. Nos. 3,951,900; 4,064,081; 4,450,260; and 5,804,645, the entireties of which are incorporated herein by reference.

### Formation of the Copolymer Dispersions

In a typical polymerization procedure, the comonomers, e.g., a vinyl ester, ethylene, cross-linking comonomer and other optional co-monomers for the first copolymer, and styrene and butadiene and other optional co-monomers for formation of the second copolymer, can be polymerized in an aqueous medium under pressures not exceeding 100 atmospheres in the presence of a catalyst and at least one emulsifying agent. The aqueous system can be maintained by a suitable buffering agent at a pH of 2 to 6, with the catalyst being added incrementally or continuously. More specifically, vinyl acetate and 50% to 75% of the other co-monomers can be suspended in water and thoroughly agitated in the presence of ethylene under the working pressure to effect solution of the ethylene in the mixture up to the substantial limit of its solubility under the conditions existing in the reaction zone. The vinyl acetate and other-co-monomers can then be gradually heated to polymerization temperature.

After an initial homogenization period, a polymerization period follows during which the catalyst, which consists of a main catalyst or initiator, and may include an activator, is added incrementally or continuously together with the remaining co-monomers. The monomers employed may be added either as pure monomer or as a premixed emulsion.

Suitable as polymerization catalysts include the water-soluble free-radical-formers generally used in emulsion polymerization, such as hydrogen peroxide, sodium persulfate, potassium persulfate and ammonium persulfate, as well as tert-butyl hydroperoxide, in amounts of between 0.01% and 3% by weight, preferably 0.01% and 1% by weight based on the total amount of the emulsion. They can be used together with reducing agents such as sodium erythorbate, sodium formaldehyde-sulfoxylate, ferrous salts, sodium dithionite, sodium hydrogen sulfite, sodium sulfite, sodium thiosulfate, erythorbic acid, ascorbic acid or Bruggolite FF-6 (formaldehyde free) (Brueggemann), as redox catalysts in amounts of 0.01% to 3% by weight, preferably 0.01% to 1% by weight, based on the total amount of the emulsion. The free-radical-formers can be charged in the aqueous emulsifier solution or be added during the polymerization in doses.

The manner of combining the polymerization ingredients can be by various known monomer feed methods such as continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

The emulsion polymerization processes used to prepare the copolymers in aqueous latex form are carried out in the presence of a stabilization system which comprises one or more anionic and/or nonionic surfactants as emulsifiers. Such emulsifiers are conventional and well known. Suitable nonionic surfactants which can be used as emulsifiers in the emulsion stabilizing system of the adhesive compositions herein include polyoxyethylene condensates. As noted above, however, such ethoxylated nonionic surfactants used to stabilize the binder dispersions of the present invention preferably do not include ethoxylated nonionics based on alkyl phenols. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic surfactants that can be used also include a series of surface active agents available from BASF under the Pluronic™ and Tetronic™ trade names. Pluronic surfactants are ethylene oxide (EO)/Propylene oxide (PO)/ethylene oxide block copolymers that are prepared by the controlled addition of PO to the two hydroxyl groups of propylene glycol. EO is then added to sandwich this hydrophobe between two hydrophilic groups, controlled by length to constitute from 10% to 80% (w/w) of the final molecule. Pluronic surfactants are PO/EO/PO block copolymers prepared by adding EO to ethylene glycol to provide a hydrophile of designated molecular weight. PO is then added to obtain hydrophobic blocks on the outside of the molecule. Tetronic surfactants are tetra-functional block copolymers derived from the sequential addition of PO and EO to ethylene-diamine. Tetronic surfactants are produced by the sequential addition of EO and PO to ethylene-diamine. In addition, a series of ethylene oxide adducts of acetyleneic glycols, sold commercially by Air Products under the Surfynol™ trade name, are suitable as nonionic surfactants.

The binder dispersions and adhesives described herein optionally are substantially free of alkylphenol ethoxylates (APEs). For purposes of this invention, such dispersions and adhesives are considered to be substantially free of APEs if they contain less than 500 wppm of APEs. In other embodiments, the dispersion, e.g., either the first dispersion or the second dispersion may comprise a minor amount of APEs.

Suitable anionic surfactants that can be used as emulsifiers in the binder latex components of the adhesives described herein, e.g., precoat or skipcoat adhesives, include alkyl aryl sulfonates, alkali metal alkyl sulfates, sulfonated alkyl esters and fatty acid soaps. Specific examples include sodium dodecylbenzene sulfonate, sodium butylnaphthalene sulfonate, sodium lauryl sulfate, disodium dodecyl diphenyl ether disulfonate, N-octadecyl sulfosuccinate and dioctyl sodiumsulfosuccinate. The surfactants are employed in amounts effective to achieve adequate emulsification of the polymer in the aqueous phase and to provide desired particle size and particle size distribution. Other ingredients known in the art to be useful for various specific purposes in emulsion polymerization, such as, acids, salts, chain transfer agents, and chelating agents, also may be employed in the preparation of the polymer. For example, if the polymerizable constituents include a monoethylenically unsaturated carboxylic acid monomer, polymerization under acidic conditions (pH 2 to 7, preferably 2 to 5) is preferred. In such instances the aqueous medium can include those known weak acids and their salts that are commonly used to provide a buffered system at the desired pH range.

The particle size of the first and second dispersions can be regulated by the quantity of non-ionic or anionic surfactants employed. To obtain smaller particles sizes, greater amounts of surfactants are used. As a general rule, the greater the amount of the surfactant employed, the smaller the average particle size.

Conventionally, various protective colloids have been used to stabilize vinyl ester/ethylene emulsion polymer latex compositions of the type hereinbefore described, instead of or in addition to the surfactant emulsifiers. It has been discovered, however, that to realize especially useful compatibility and processing benefits, the adhesives of the present invention, in some embodiments, should be kept substantially free of such protective colloids such as polyvinyl alcohol (PVOH) and other conventional protective colloid-forming materials. In other embodiments, however, it is contemplated that the adhesives of the invention may comprise a minor amount of protective colloids such as PVOH.

While some amounts of protective colloid materials can be tolerated, and may in fact be useful in processing the binder emulsion component of the adhesives used herein, the binders described herein (first and/or second dispersion) preferably contain, respectively, no more than about 1.0 pphm and preferably no more than about 0.5 pphm or no more than 0.25 pphm of protective colloid materials. Binder emulsions using surfactant-based stabilizing systems and containing no more than these amounts of protective colloid-forming materials are considered for purposes of this invention to be “substantially free” of protective colloid materials. The latex emulsions which utilize such stabilizing systems are also those characterized herein as being “substantially all-surfactant-based” emulsions.

Following polymerization, the solids content of the resulting aqueous polymer emulsion binders can be adjusted, as described above, to the level desired by the addition of water or by the removal of water by distillation. Generally, the desired level of polymeric solids content is from about 40 weight percent to about 70 weight percent based on the total weight of the emulsion, more preferably from about 50 weight percent to about 60 weight percent. The adhesive formulated from the emulsion optionally has a solids content from 40 to 85 wt. %, e.g., from 60 to 85 or from 75 to 85 wt. %. The precoat adhesive preferably has a viscosity ranging from 2,000 to 60,000 cP, e.g., from 2,000 to 20,000 cP or from 5,000 to 15,000 cP.

If desired, conventional additives may be incorporated into the carpet adhesive, e.g., precoat and/or skipcoat, used herein in order to modify the properties thereof. Among these additives may be included fillers, thickeners, catalysts, dispersants, colorants, biocides, froth aids, etc.

In particular, the ability to load the adhesives with high amounts of fillers such as calcium carbonate, aluminum trihydrate, barium, feldspar, recycled fillers, etc., permits an increase in the superior flame retardency and low smoke properties the copolymer already has. Preferred adhesives in accordance with the present invention are loaded with filler to yield a composition comprising from about 10 to about 50 weight percent copolymer, and from about 50 to about 90 weight percent filler, based on total weight of the composition, depending in part on the type and form of the carpet being constructed.

### EXAMPLES 1-10

The carpet adhesives used to prepare the carpet products of the present invention are illustrated by the following Examples. A number of different carpet binder emulsions, and carpet adhesives made therefrom, were prepared from experimental samples or from various commercially available vinyl acetate/ethylene copolymer emulsions, as indicated in Table 1, below. Some of these binders and compositions utilize all of the elements of the binders and adhesives as described in the claims herein. Others of these binders and compositions do not utilize all of the claim elements and are thus comparative. Examples 7-10 reflect carpets formed using commercially available styrene/butadiene adhesives for comparison. The binders were formulated, as described below, into precoat and skip coat compositions and were used to prepare carpet test samples for further analysis.

### Binder Emulsion Preparation

A number of binder emulsions based on vinyl acetate/ethylene (VAE) copolymers were prepared using the general polymerization techniques described in Comparative Example 1 and in Examples 1-4 of U.S. Pat. No. 5,576,384, incorporated herein by reference, were acquired from various commercially available VAE emulsions, or were prepared through experimental formulations (Examples 3 & 4). The copolymers in the emulsions made may contain relatively small amounts of additional co-monomers including some of the ionic emulsion stabilizing co-monomers and/or some of the unsaturated cross-linking co-monomers used in the present invention to modify the film elongation properties of films made from the emulsions containing these VAE-based copolymers. All of the VAE binder emulsions made were emulsified with various amounts of anionic and/or nonionic emulsifiers. Some of the binder emulsions made also contained varying amounts of protective colloids based on polyvinyl alcohol (PVOH) or hydroxyethyl cellulose.

Neat polymer films formed from several binder emulsions were evaluated for their film elongation properties in accordance with the Film Elongation Test, described below. Results of the Film Elongation Testing at 110° C. are also shown in Table 1.

### Precoat Formulations

Certain of the binder emulsion formulations hereinbefore described were formulated into precoat compositions suitable for application to a tuft-containing primary carpet backing. Such precoat formulations had the following composition:

PRECOAT

| Ingredients | Pts by Wt (Dry) | Pts by Wt (Wet) |
|---|---|---|
| Binder at 55% Solids | 100.0 | 181.8 |
| Water | 0.0 | 36.6 |
| Polyacrylate | 0.5 | 2.0 |
| Dispersant | | |
| Calcium Carbonate | 500.0 | 500.0 |
| Froth Aid (SLS) | 1.8 | 6.0 |

| | |
|---|---|
| Thickener: | as needed for 9000-10,000 visc |
| | (Brookfield at 20 rpm) |

Total Composition Solids = 82.9%

SLS=sodium lauryl sulfate is a surfactant used to help froth the composition.

The precoat compositions were applied to a carpet which employs polypropylene face yarns which are tufted into a woven polypropylene primary tufting substrate. The precoat composition was frothed and then coated onto the back of the carpet. Target dry precoat add-on weights were in the range of 22-24 ounces per sq yard (746 g/m² to 814 g/m²).

### Skip Coat Formulations

The binder emulsion formulations hereinbefore described were also formulated into skip coat compositions suitable for attaching a scrim to the back of a carpet substrate. Such skip coat compositions were applied to the scrim, and the scrim was then applied to the back of the carpet before going into an oven. The purpose of the skip coat adhesive is to provide a layer of composition or adhesive which will adhere the woven scrim to the back of the carpet. The skip coat composition is usually lower in filler loading than the precoat compound and higher in viscosity. The viscosity will be dependent upon the type of applicator system being utilized for the skip coat. A typical skip coat formulation using binders such as those described in Table 1 is set forth as follows:

SKIP COAT

| Ingredients | Pts by Wt (Dry) | Pts by Wt (Wet) |
|---|---|---|
| Binder at ~55% Solids | 100.0 | 181.8 |
| Water | 0.0 | 16.8 |
| Polyacrylate | 0.5 | 2.0 |
| Dispersant | | |
| Calcium Carbonate | 400.0 | 400.0 |
| Optional Froth Aid | 1.8 | 6.0 |
| (SLS) | | |

| | |
|---|---|
| Thickener: | As needed for 14,000-15,000 visc |
| | (Brookfield at 20 rpm) |

Total Composition Solids = 82.8%

The secondary scrim backing material that is attached to the carpet using the skip coat is typically made of polypropylene. This material can be an open weave construction with the size of the openings in the range of ⅛ inches× 3/16 inches (0.32 cm×0.48 cm). The scrim weights are typically in the range of 0.7 to 1.1 oz per sq yd (23.7 to 37.3 g/m²).

The skip coat composition can also be frothed in order to achieve the needed weights but may not need to be frothed. Target dry skip coat weights were in the range of 8-10 ounces per sq yard (271 g/m² to 339 g/m²). The skip coat composition was applied to the polypropylene scrim, and then the scrim was married to the back of the carpet which was still wet with the precoat composition. The carpet and scrim were then dried in an oven at 130° C. for 15-20 minutes.

### Test Methods

Test methods that may be used to evaluate carpet adhesives may be carried out as follows:

### Film Elongation Test

This test evaluates the characteristics of neat films which are prepared by drying the binder latex emulsions that form the basis of carpet adhesives of the type used in the carpet products described herein. This test was developed as a way to simulate the processing issues which have been experienced in the past with, for example, VAE emulsion polymers, especially those which are partially or mostly surfactant stabilized.

Carpet coated with compositions used as a precoat or skip coat typically exits the drying ovens at 110-120° C. and then travels over a series of guide rollers and possibly through a shearing machine. As indicated above, if the latex binder of the adhesive will flow under heat, it can then transfer to these processing rollers and create build-up which can cause maintenance issues. In addition, at times this build-up can transfer back to the carpet which can cause gouges in the face of the carpet as it goes through the shearing machine. The present invention advantageously provides adhesives suitable for carpet precoats that may not exhibit such undesirable properties.

The Film Elongation Test involves drying emulsion polymer latex compositions into films having a thickness of from about 0.045-0.055 inches (0.11 to 0.14 cm) and having an overall length of 3 inches (7.6 cm). The films are then marked to show 2 inches (5.1 cm). A 50 gram weight is attached to the bottom of the film, and a clamp is attached to the top of the film to allow the film to be hung in an oven. After hanging in the oven for 20 minutes at 110° C., the original 2 inch length (L1) is remeasured to determine its new length (L2).

The % elongation is then calculated as follows:

% Elongation at High Temperature=(L2−L1)/L1×100.

Binders which exhibit lower elongation values can be used to form adhesives which can be run in the carpet manufacturing process with few or no problems relating to coating build-up and transfer-back to and from processing rollers. Nevertheless, as indicated above, the carpet adhesives of the invention have elongation values greater than 125%, but surprisingly and unexpectedly may still provide desirable processing characteristics, particularly if the adhesives are employed in a carpet precoat. Table 1 lists elongation values for various commercially available and experimental VAE-based adhesives and SB-based adhesives. Any of the adhesives having a cross-linking comonomer and having elongation values greater than 125% at 110° C. may be used in combination with a styrene-butadiene-based skipcoat adhesive according to the present invention.

TABLE 1
Carpet adhesives and Exhibited Elongation Data

| | | | Elongation |
|---|---|---|---|
| Ex. | Copolymer | Cross-linker | at 110° C. |
| 1 | VAE Emulsion 1 | NMA¹ | 300+ |
| | Vinnapas 100HS | | |
| 2 | VAE Emulsion 2 | GMA² | 300+ |
| | Vinamul 3925 | | |
| 3 | VAE Emulsion 3³ | Silane | 125 |
| 4 | VAE Emulsion 4⁴ | DAP⁵ | 125 |
| 5 | Emulsion 5 (Comp) | None | 300+ |
| | Vinnapas EF 8001 | | |
| 6 | Emulsion 6 (Comp) | Silane | 6 |
| | TufCOR C-845 | | |
| 7 | SBR 1 (Comp) | None | 6 |
| | GenCal 7555D | | |
| 8 | SBR 2 (Comp) | None | 19 |
| | Rovene 4487 | | |
| 9 | SBR 3 (Comp) | None | 13 |
| | Styrofan NX 4628 | | |
| 10 | SBR 4 (Comp) | None | 6 |
| | Styron 8476 | | |

¹NMA = n-methylol acrylamide
²GMA = glycidyl methacrylate
³85.5 parts VA and 14.5 parts C₂H₄
⁴86.9 parts VA and 13.1 parts C₂H₄
⁵DAP = diallyl phthalate

### Tuft Bind Testing

Once the binder emulsions described herein are formulated into adhesives, several tests can be used to determine the effectiveness of such adhesives. When an adhesive herein is to be used as a precoat to lock tufts into a primary backing substrate, a Tuft Bind test can be used to evaluate the effectiveness of the composition as a precoat. This test measures the amount of force (in lbs or Newtons) that is required to pull a tuft through the primary tufting substrate. Testing is done similar to ASTM D1335-05 but with certain minor changes. Individual tufts are hooked with a metal device, and this device is placed in top jaw of an Instron apparatus. The carpet is then attached to the bottom jaw of the Instron. The jaws are separated at a rate of 12 inches per minute (30.5 cm/min). Approximately 10 tufts are pulled for each carpet sample, and the values from each pull recorded by the Instron are averaged. Results are reported in lbs force or Newtons. Carpet compositions formed from the adhesives of the invention preferably exhibit desirable physical properties such as tuft bind values (for loop carpet) greater than 20 N or greater than 27 N. Values for cut pile carpet would be expected to be lower. Delamination Testing

When an adhesive, e.g., styrene/butadiene-based adhesive, as described herein is as a skip coat adhesive to attach a scrim as a secondary backing to the back of precoated carpet a delamination test can be used to evaluate the effectiveness of the adhesive combinations. This test measures the adhesive strength property of the carpet adhesive in securing the polypropylene secondary backing by testing the force required to separate the coated carpet from the polypropylene secondary backing. This test is done similar to ASTM D 3936-05 but with some slight modifications. The major difference in the test is that the average force in lbs-force recorded by an Instron is used rather than selecting the best six peaks over a 3 inch (7.6 cm) area of the curve. The clamps of the Instron are then separated at a rate of 12 inches per minute (30.5 cm/min), and the average force required to separate the polypropylene secondary backing from the coated carpet is measured and recorded. Carpet compositions formed from the adhesives of the invention preferably exhibit dry delamination values, as defined herein, of greater than 9 N, greater than 11 N, or greater than 14 N.

While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of the patentable novelty which reside in the present disclosure, including all features which would be treated as equivalents thereof by those skilled in the art to which the disclosure pertains.

We claim:

1. A carpet product, comprising:
a primary carpet layer comprising carpet fiber tufted into a primary backing and a precoat adhesive adhering said carpet fiber to said primary backing, wherein the adhesive is formed from a latex adhesive comprising a first copolymer of an alkanoic acid having from 1 to 13 carbon atoms, ethylene and a cross-linking co-monomer, wherein the first copolymer exhibits an elongation value greater than 125% at 110° C.; and
a secondary backing adhered to said primary backing with a skipcoat adhesive comprising styrene/butadiene second copolymer.

2. The carpet product of claim 1, wherein the latex precoat adhesive is stabilized with a stabilizing system which comprises one or more anionic and/or nonionic surfactants, said stabilizing system being present in an amount which is effective to disperse the copolymer in the water.

3. The carpet product of claim 2, wherein the stabilizing system further comprises polyvinyl alcohol.

4. The carpet product of claim 2, wherein the stabilizing system further comprises less than 1.0 pphm polyvinyl alcohol.

5. The carpet product of claim 2, wherein the stabilizing system further comprises hydroxyethyl cellulose.

6. The carpet product of claim 1, wherein the first copolymer has an elongation less than 500% at 110° C.

7. The carpet product of claim 1, wherein the first copolymer has an elongation less than 350% at 110° C.

8. The carpet product of claim 1, having a tuft bind value greater than 20 N.

9. The carpet product of claim 1, having a tuft bind value greater than 27 N.

10. The carpet product of claim 1, wherein the first copolymer is a copolymer of the vinyl ester of an alkanoic acid having from 1 to 13 carbon atoms, ethylene, and an acrylic monomer or ester thereof.

11. The carpet product of claim 1, wherein the first copolymer comprises a copolymer of vinyl acetate, vinyl neodecanoate and ethylene.

12. The carpet product of claim 1, wherein the cross-linking co-monomer is selected from the group consisting of triallyl cyanurate, triallyl isocyanurate, diallyl maleate, diallyl fumarate, divinyl benzene, diallyl phthalate, silanes, and GMA.

13. The carpet product of claim 1, wherein the precoat adhesive and/or the skipcoat adhesive further comprises a filler selected from the group consisting of calcium carbonate, ATH aluminum trihydrate, recycled fillers, ground glass, silica, fly ash, and combinations of said fillers.

14. The carpet product of claim 1, wherein the first copolymer comprises from 70 to 90 pphm vinyl acetate and from 10 to 30 pphm of ethylene.

15. The carpet product of claim 1, wherein the precoat adhesive has a solids content from 40 to 85 wt. %.

16. The carpet product of claim 1, wherein the precoat adhesive has a viscosity from 2,000 to 60,000 cP.

17. The carpet product of claim 1, wherein the first copolymer is a copolymer of at least a vinyl ester of an alkanoic acid having from 1 to 13 carbon atoms, ethylene, a cross-linking co-monomer, and a carboxyl monomer.

18. A process for forming a carpet product, the process comprising the steps of:
(a) providing a precoat adhesive comprising a latex coating composition comprising a first copolymer of an alkanoic acid having from 1 to 13 carbon atoms, ethylene and a cross-linking co-monomer, wherein the first copolymer exhibits an elongation value greater than 125% at 110° C.;
(b) providing a primary carpet layer comprising carpet fiber tufted into a primary backing;
(c) applying the precoat adhesive to the primary carpet layer;
(d) applying a skipcoat adhesive comprising a second copolymer to either or both the primary carpet layer and/or a secondary backing, wherein the second copolymer is a copolymer of at least styrene and butadiene; and
(e) drying the precoat adhesive and the skipcoat adhesive under conditions effective to adhere the carpet fiber to the primary backing, and adhere the primary carpet layer to the secondary backing.

19. The process of claim 18, wherein the latex adhesive is stabilized with a stabilizing system which comprises one or more anionic and/or nonionic surfactants, said stabilizing system being present in an amount which is effective to disperse the copolymer in the water.

20. The process of claim 19, wherein the stabilizing system further comprises polyvinyl alcohol.

21. The process of claim 19, wherein the stabilizing system further comprises less than 1.0 pphm polyvinyl alcohol.

22. The process of claim 18, wherein the first copolymer has an elongation less than 500% at 110° C.

23. The process of claim 18, wherein the first copolymer has an elongation less than 350% at 110° C.
